(19) United States
(12) Patent Application Publication
(10) Pub. No.: US 2019/0107183 A1
(43) Pub. Date: Apr. 11, 2019

(54) TRANSMISSION DEVICE

(71) Applicant: MUSASHI SEIMITSU INDUSTRY CO., LTD., TOYOHASHI-SHI, AICHI (JP)

(72) Inventor: Shinya MATSUOKA, TOYOHASHI-SHI, AICHI (JP)

(21) Appl. No.: 16/087,910

(22) PCT Filed: Mar. 28, 2017
(86) PCT No.: PCT/JP2017/012724

§ 371 Date: Sep. 24, 2018

(30) Foreign Application Priority Data
Mar. 30, 2016 (JP) 2016-069562

(51) Int. Cl. F16H 25/06; F16H 48/14; F16H 57/04

(52) U.S. Cl. CPC F16H 25/06; F16H 2025/063; F16H 57/04; F16H 48/14

(57) ABSTRACT

A transmission device includes one transmission member having a first axis, the other transmission member being capable of revolving around the first axis while rotating around a second axis eccentric from the first axis, and a transmission mechanism provided between the two transmission members, and that has one of transmission grooves provided in the one transmission member and having a wave-shaped annular form with the first axis, the other transmission groove provided in the other transmission member, having a wave-shaped annular form with the second axis, and a plurality of rolling bodies disposed in a plurality of intersecting parts between the two transmission grooves, wherein opposite side faces of a retainer are formed so as to be rotatably slidable with respect to the transmission members, and oil reservoir recesses are provided to one opposing face of the mutually opposing faces of the transmission members and the retainer.

### TECHNICAL FIELD

The present invention relates to a transmission device, and in particular to a transmission device that includes a pair of transmission members that oppose each other, and a transmission mechanism that is provided between the two transmission members and can transmit torque while changing a speed therebetween, one transmission member having a first axis as a central axis, the other transmission member being capable of revolving around the first axis while rotating around a second axis that is eccentric from the first axis.

### BACKGROUND ART

The above transmission device is conventionally known, as shown for example in FIG. 7 of Patent Document 1, and in this arrangement a transmission mechanism includes one transmission groove that is present in a face of one transmission member opposing another transmission member and has a wave-shaped annular form having a first axis as the center, another transmission groove that is present in a face of the other transmission member opposing the one transmission member, has a wave-shaped annular form having a second axis as the center, and has a wave number that is different from that of the one transmission groove, and a plurality of rolling bodies disposed between a plurality of intersecting parts of the two transmission grooves. This arrangement has the advantage that the axial dimension of the transmission device can be made small by for example forming each transmission member into a plate shape.

### RELATED ART DOCUMENTS

### Patent Documents

Patent Document 1: Japanese Patent Application Laid-open No. 2010-14214

### SUMMARY OF THE INVENTION

### Problems to be Solved by the Invention

In the conventional transmission device shown in FIG. 7 of Patent Document 1, a ring plate-shaped retainer having a plurality of retaining holes rotatably and slidably retaining a plurality of rolling bodies (balls) is disposed between the pair of transmission members in the above transmission mechanism. The retainer can facilitate the operation of engaging the plurality of rolling bodies with mutually overlapping parts of the mutually opposing transmission grooves of the pair of transmission members by disposing the retainer between the pair of transmission members in a state in which the plurality of rolling bodies are arranged at equal intervals in the peripheral direction in the retaining holes.

In this way, the retainer can function as an assembly jig when assembling the device, but while carrying out transmission after the device is assembled, the retainer retains the plurality of rolling bodies rolling along the two transmission grooves while rotating relative to the pair of transmission members, which are rotating eccentrically to each other, causing the problem that the retainer becomes a resistance load for this eccentric rotation, and it is surmised that this will degrade the transmission efficiency of the transmission device (see for example [0004] of Patent Document 1).

The present invention has been accomplished in light of such circumstances, and it is an object thereof to provide a transmission device that enhances the transmission efficiency by utilizing a retainer so that disturbance when a rolling body passes through a portion of the transmission groove where the curvature changes sharply can be suppressed effectively and by enhancing an effect in lubricating a face via which the retainer and the transmission member contact each other to thus enable the resistance load due to the retainer to be decreased.

### Means for Solving the Problems

In order to attain the above object, according to a first aspect of the present invention, there is provided a transmission device comprising a pair of transmission members that oppose each other, a transmission mechanism that is provided between the two transmission members and can transmit torque while changing a speed therebetween, and a casing that houses the two transmission members, lubricating oil being supplied to an interior of the casing, one transmission member having a first axis as a central axis, the other transmission member being capable of revolving around the first axis while rotating around a second axis that is eccentric from the first axis, the pair of transmission members each having a transmission groove in mutually opposing faces of the two, the transmission mechanism comprising one of the transmission grooves provided in the one transmission member and having a wave-shaped annular form with the first axis as a center, the other transmission groove provided in the other transmission member, having a wave-shaped annular form with the second axis as a center, and having a wave number that is different from a wave number of the one transmission groove, a plurality of rolling bodies disposed in a plurality of intersecting parts between the one transmission groove and the other transmission groove and carrying out speed change and transmission between the two transmission members while rolling in the two transmission grooves, and a plate-shaped retainer having a plurality of retaining holes retaining the rolling bodies and being relatively rotatably disposed between the two transmission members, wherein the retainer is formed to have a plate thickness so that opposite side faces of the retainer are rotatably slidable with respect to the two transmission members, and at least one opposing face of mutually opposing faces of the retainer and each of the two transmission members is provided with a plurality of oil reservoir recesses that can retain lubricating oil between the one opposing face and the other opposing face.

Further, according to a second aspect of the present invention, there is provided a transmission device comprising a first transmission member having a first axis as a central axis, an eccentric rotating member having integrally linked a first transmission shaft rotating around the first axis and an eccentric shaft portion having a second axis eccentric from the first axis as a central axis, a second transmission member supported on the eccentric shaft portion so that the second transmission member can rotate around the second axis and opposing the first transmission member, a third transmission member coaxially linked to a second transmission shaft rotating around the first axis and opposing the second transmission member, a first transmission mechanism capable of transmitting torque between the first and second transmission members while changing a speed, a second transmission mechanism capable of transmitting torque between the second and third transmission members while changing a speed, and a casing housing the first to third transmission members and having the first transmission member linked thereto so as to rotate as a unit, lubricating oil being supplied to an interior of the casing, the first transmission mechanism having a first transmission groove that is present in an opposing face of the first transmission member opposing the second transmission member and has a wave-shaped annular form having the first axis as a center, a second transmission groove that is present in an opposing face of the second transmission member opposing the first transmission member, has a wave-shaped annular form having the second axis as a center, and has a different wave number from a wave number of the first transmission groove, a plurality of first rolling bodies that are disposed in a plurality of intersecting parts of the first and second transmission grooves and carry out speed change and transmission between the first and second transmission members while rolling in the first and second transmission grooves, and a plate-shaped first retainer that has a plurality of first retaining holes rotatably and slidably retaining the first rolling bodies and is disposed between the first and second transmission members, the second transmission mechanism having a third transmission groove that is present in an opposing face of the second transmission member opposing the third transmission member and has a wave-shaped annular form having the second axis as a center, a fourth transmission groove that is present in an opposing face of the third transmission member opposing the second transmission member, has a wave-shaped annular form having the first axis as a center, and has a different wave number from a wave number of the third transmission groove, a plurality of second rolling bodies that are disposed in a plurality of intersecting parts of the third and fourth transmission grooves and carry out speed change and transmission between the second and third transmission members while rolling in the third and fourth transmission grooves, and a plate-shaped second retainer that has a plurality of second retaining holes rotatably and slidably retaining the second rolling bodies and is disposed between the second and third transmission members, wherein the casing is housed within the transmission case, and first and second bearing bosses rotatably supported on the transmission case are connectedly provided on one side wall and another side wall of the casing respectively, the first transmission shaft can be coaxially linked to a first drive shaft rotatably supported on the first bearing boss, the second transmission shaft can be coaxially linked to a second drive shaft rotatably supported on the second bearing boss, rotational torque can be distributed from the casing to the first and second drive shafts via the first and second transmission shafts, the first retainer is formed to have a plate thickness so that opposite side faces of the first retainer are rotatably slidable with respect to the first and second transmission members, the second retainer is formed to have a plate thickness so that opposite side faces of the second retainer are rotatably slidable with respect to the second and third transmission members, a plurality of first oil reservoir recesses are provided in at least one opposing face among mutually opposing faces of the first retainer and each of the first and second transmission member, the first oil reservoir recesses being capable of retaining lubricating oil between the first oil reservoir recesses and the other opposing face, and a plurality of second oil reservoir recesses are provided in at least one opposing face of mutually opposing faces of the second retainer and each of the second and third transmission members, the second oil reservoir recesses being capable of retaining lubricating oil between the second oil reservoir recesses and the other opposing face.

Furthermore, according to a third aspect of the present invention, in addition to the second aspect, the transmission device comprises first and second oil inlet paths guiding lubricating oil from an interior of the transmission case toward an inner periphery of the first and second retainers via each of fitting faces between the first and second bearing bosses and the first and second drive shafts.

Moreover, according to a fourth aspect of the present invention, in addition to any one of the first to third aspects, the oil reservoir recess is formed from a plurality of channels provided in an opposing face of the retainer having a ring plate shape opposing the transmission member and transecting the retainer in a radial direction, and opposite ends of the channel open on an inner peripheral face and an outer peripheral face of the retainer respectively.

Further, according to a fifth aspect of the present invention, in addition to any one of the first to third aspects, the oil reservoir recess is formed from a plurality of dimples indented in the at least one opposing face with gaps therebetween.

In the present invention and the present specification, a ‘plate thickness that is rotatably slidable’ not only includes a plate thickness of a retainer that attains a state in which mutually opposing faces of the retainer and each transmission member are in physical contact with each other in a rotatably slidable state, but also includes a plate thickness of a retainer that allows the retainer and each transmission member to be in a substantially contacted state in which they closely oppose each other in a state in which there is a small clearance that enables an oil film necessary for lubrication to be formed and retained on the mutually opposing faces. Furthermore, it includes a plate thickness of a retainer that attains a state in which the mutually opposing faces are not always in a physically abutting state but at least during transmission the retainer temporarily abuts against the transmission member by tilting slightly within the range of the clearance or by moving in the axial direction.

### EFFECTS OF THE INVENTION

In accordance with the first aspect of the present invention, since the retainer disposed between the mutually opposing transmission members and retaining the plurality of rolling bodies in the intersecting parts between the wave-shaped annular transmission grooves of the two transmission members is formed so as to have a plate thickness that is rotatably slidable with respect to the first and second transmission members sandwiching it from opposite sides, it is possible to increase the plate thickness of the retainer as much as possible to thus enhance the rigidity with which the retainer retains the rolling bodies, and the plurality of rolling bodies can be appropriately retained by the retainer during transmission. Because of this, the retainer can suppress effectively disturbance of some of the plurality of rolling bodies in cooperation with the other rolling bodies when the some of the rolling bodies are about to be disturbed when passing through a sharply changing curvature part of the transmission groove, thus ensuring that all of the plurality of rolling bodies roll smoothly along the transmission groove. Furthermore, when lubricating oil within the casing enters, by capillary action, between the mutually opposing faces of the retainer and the transmission member during transmission, an oil film is formed on the mutually opposing faces, but in the present invention in particular since the plurality of oil reservoir recesses are provided in at least one of the mutually opposing faces of the transmission member and the retainer, the oil reservoir recesses being capable of retaining lubricating oil between themselves and the other opposing face, some of the lubricating oil forming the oil film moves accompanying relative rotation between the transmission member and the retainer and becomes easily trapped and retained by the oil reservoir recesses. Since the lubricating oil thus trapped and retained can prevent effectively the oil film on the mutually opposing faces from becoming discontinuous, the effect of the oil film in lubricating the mutually opposing faces is sufficiently exhibited, thus enabling the frictional resistance of the retainer with respect to the transmission member to be reduced effectively. From the above, the overall transmission efficiency of the transmission device can be enhanced effectively.

Furthermore, in accordance with the second aspect, in addition to the effects due to the above first aspect, the transmission device can be utilized effectively as a differential device in which the casing is used as a differential case.

Moreover, in accordance with the third aspect, since the oil inlet path is provided for guiding lubricating oil from the interior of the transmission case toward the inner periphery of the first and second retainers via the fitting faces between the first and second bearing bosses of the casing (differential case) and the first and second drive shafts, lubricating oil that has been guided toward the inner periphery of each retainer through the oil inlet path can efficiently and sufficiently form an oil film on the mutually opposing faces of the retainer and the transmission member by means of centrifugal force due to rotation of the retainer and capillary action, and this enables the transmission efficiency of the differential device to be further improved.

Furthermore, in accordance with the fourth aspect, since the oil reservoir recess is formed from a plurality of channels transecting the ring plate-shaped retainer in the radial direction, and opposite ends of the channel open on the inner peripheral face and the outer peripheral face of the retainer respectively, while the transmission mechanism is carrying out transmission, old lubricating oil is sufficiently replaced with new in each channel, and this enables a new oil film to be always formed on the mutually opposing faces of the retainer and the transmission members on opposite sides, thus enhancing the transmission efficiency and enabling the mutually opposing faces to be efficiently cooled.

Moreover, in accordance with the fifth aspect, since the oil reservoir recess is formed from the plurality of dimples indented with a gap therebetween in at least one of the opposing faces, even in a state in which the transmission mechanism is stopped for a long period of time, it becomes possible to continue to retain sufficient lubricating oil in each dimple, and this enables an oil film to be quickly formed on the mutually opposing faces of the retainer and the transmission members on opposite sides from the time of starting operation of the transmission mechanism, thus enhancing the transmission efficiency.

### BRIEF DESCRIPTION OF DRAWINGS

FIG. 1 is a vertical sectional view of a transmission device (differential device) related to a first embodiment of the present invention. (first embodiment)

FIG. 2 is a sectional view along line 2-2 in FIG. 1. (first embodiment)

FIG. 3 is a sectional view along line 3-3 in FIG. 1. (first embodiment)

FIG. 4 is a sectional view along line 4-4 in FIG. 1. (first embodiment)

For FIG. 5, FIG. 5 (A) is an enlarged view from arrow 5(A) in FIG. 1 and FIG. 5 (B) is an enlarged view from arrow 5(B) in FIG. 1. (first embodiment)

FIG. 6 is a perspective view of a first retainer on its own. (first embodiment)

FIG. 7 is a perspective view of a first retainer on its own related to a second embodiment of the present invention (corresponding to FIG. 6). (second embodiment)

FIG. 8 is an enlarged sectional view along line 8-8 in FIG. 7. (second embodiment)

### EXPLANATION OF REFERENCE NUMERALS AND SYMBOLS

A1, A2 First and second drive axles (first and second drive shafts)
B1, B2 First and second bearing bosses
C Differential case (casing)
Ca, Cb First and second side walls (one side wall and other side wall)
D Differential device (transmission device)
H1, H2 First and second retainers
S1, S2 First and second transmission shafts
T1, T2 First and second transmission mechanisms (transmission mechanism)
X1, X2 First and second axes
1 Transmission case
5 First transmission member (one transmission member)
6 Eccentric rotating member
6e Eccentric shaft portion
8 Second transmission member (other transmission member)
9 Third transmission member (one transmission member)
21, 25 First and fourth transmission grooves (one transmission groove)
22, 24 Second and third transmission grooves (other transmission groove)
23, 26 First and second balls (rolling body)
61, 62 Channel (oil reservoir recess, first and second oil reservoir recesses)
61′, 62′ Dimple (oil reservoir recess, first and second oil reservoir recesses)

### Modes for Carrying Out the Invention

Embodiments of the present invention are explained below by reference to the attached drawings.

### First Embodiment

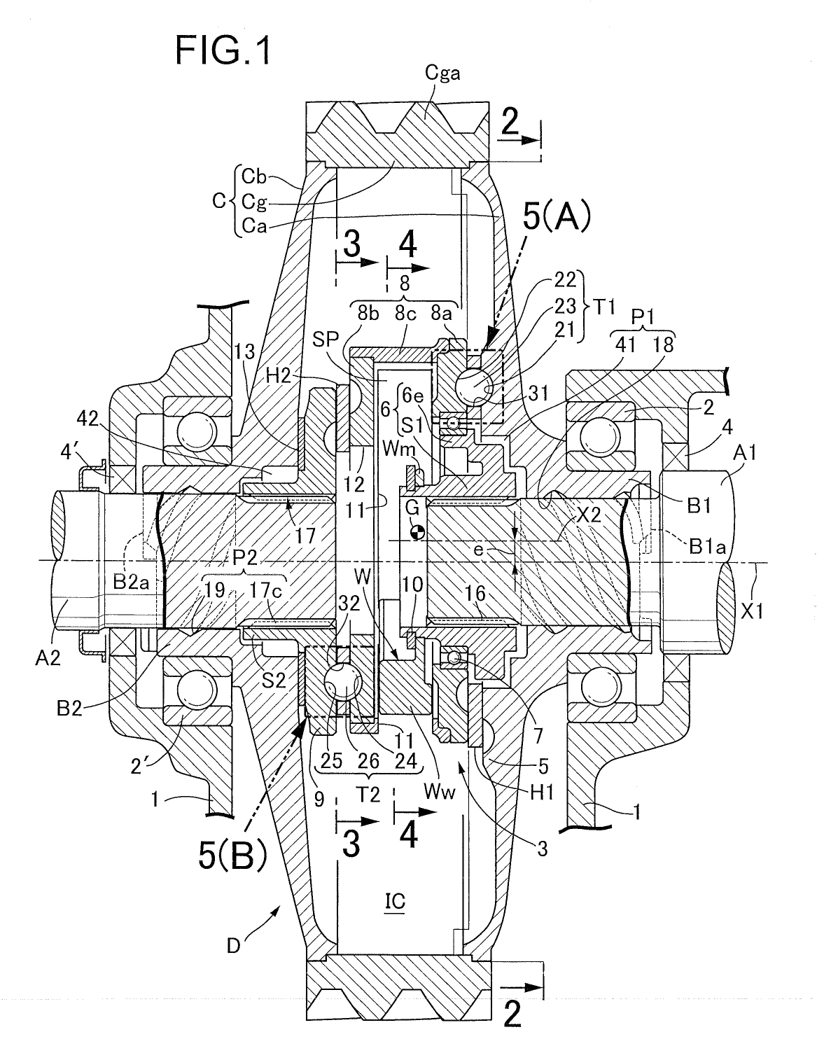

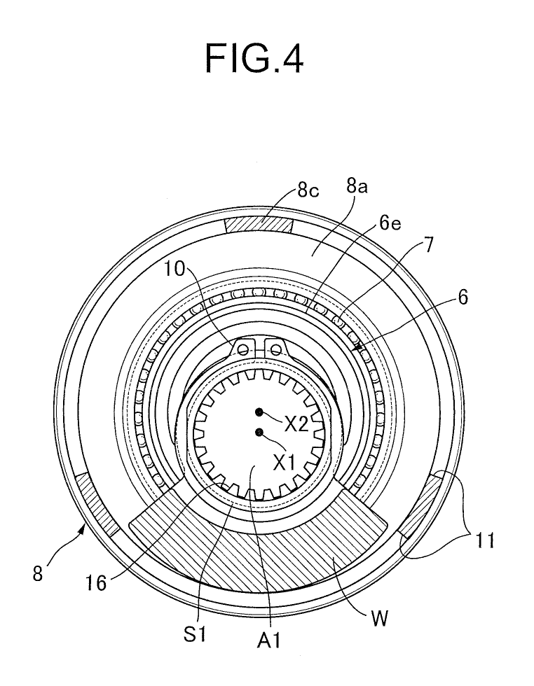

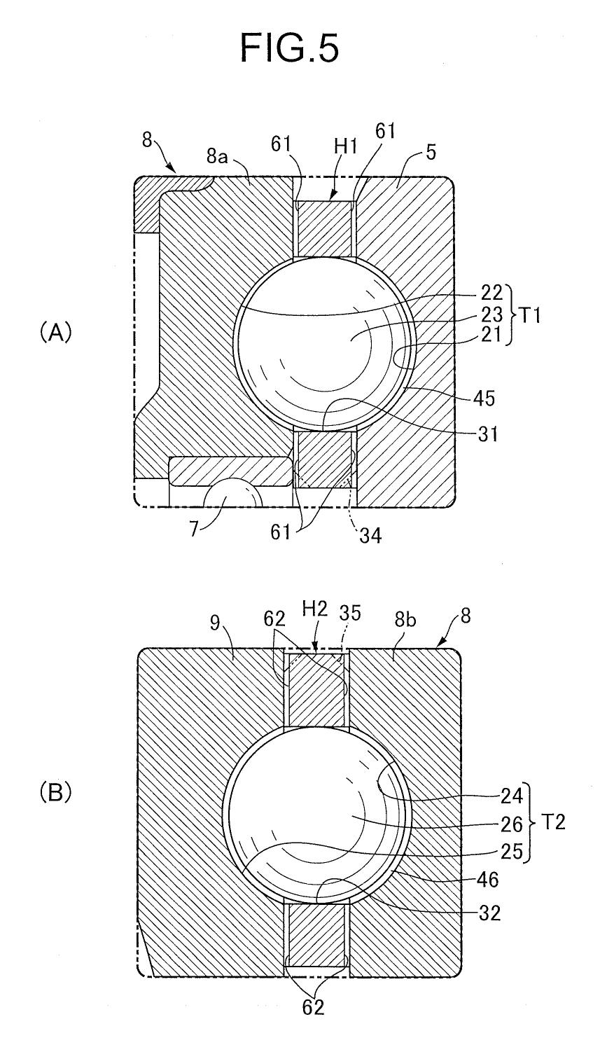

A first embodiment of the present invention shown in FIG. 1 to FIG. 6 is now explained. In FIG. 1, a differential device D as a transmission device and a gearbox are together housed within a transmission case 1 of an automobile.

This differential device D distributes rotation of a ring gear Cg, which rotates in association with the output side of the gearbox, between left and right drive axles A1 and A2 (that is, first and second drive shafts) relatively rotatably arranged on a central axis, that is, a first axis X1, of the differential device D while allowing differential rotation between the two drive axles A1 and A2. Seal members 4 and 4′ provide sealing between each of the drive axles A1 and A2 and the transmission case 1.

A bottom part of the transmission case 1 is formed as an oil pan (not illustrated) that can collect a predetermined amount of lubricating oil. The lubricating oil collected within the oil pan is stirred vigorously by rotation of a rotating portion, for example, a differential case C, which is described later, within the transmission case 1 and is scattered over a wide range in the space within the case 1, this scattered lubricating oil being capable of lubricating each part within the case 1, that is, parts that are to be lubricated. In addition to the above lubricating structure (or instead thereof), lubricating oil fed under pressure by pumping means such as an oil pump may be forcibly supplied under pressure to each part within the transmission case 1.

The differential device D is formed from the differential case C and a differential mechanism 3 housed within the differential case C and described later, the differential case C being a transmission case supported on the transmission case 1 so that it can rotate around the first axis X1. The differential case C includes the ring gear Cg, which is formed from a helical gear having helical teeth Cga provided on the outer periphery of a short cylindrical gear main body, and a pair of left and right first and second side walls Ca and Cb having outer peripheral end parts joined to axially opposite end parts of the ring gear Cg. At least one of the side walls Ca and Cb is provided with a drain hole (not illustrated) in the vicinity of the outer peripheral end, the drain hole being capable of appropriately discharging excess lubricating oil within the differential case C by means of centrifugal force, etc.

Furthermore, the first and second side walls Ca and Cb each integrally have cylindrical first and second bearing bosses B1 and B2 arranged on the first axis X1 on respective inner peripheral end parts, and outer peripheral parts of the bearing bosses B1 and B2 are rotatably supported on the transmission case 1 via bearings 2 and 2′. Furthermore, the first and second drive axles A1 and A2 are each fitted into and supported on inner peripheral parts of the first and second bearing bosses B1 and B2 so that the first and second drive axles A1 and A2 can rotate around the first axis X1. First and second helical grooves 18 and 19 are formed in at least one of the fitting faces thereof (in the illustrated example the inner peripheral faces of the bearing bosses B1 and B2), the first and second helical grooves 18 and 19 drawing in scattered lubricating oil within the transmission case 1 into the differential case C accompanying relative rotation between the bearing bosses B1 and B2 and the drive axles A1 and A2 at least while the automobile is moving forward (that is, while the drive axles A1 and A2 are rotating forward). The outer end of each of the helical grooves 18 and 19 opens within the transmission case 1 and the inner end opens within the differential case C. Furthermore, guide parts B1a and B2a are projectingly provided on outer end faces of the bearing bosses B1 and B2, the guide parts B1a and B2a being capable of efficiently guiding the flow of lubricating oil from the interior of the transmission case 1 into the outer end opening (that is, the inlet) of each of the helical grooves 18 and 19.

In the present embodiment, the helical grooves 18 and 19 are illustrated as lubricating oil supply means for supplying lubricating oil within the transmission case 1 into the differential case C, but in addition to such helical grooves 18 and 19 (or instead thereof), as other lubricating oil supply means, for example, lubricating oil fed under pressure by pumping means such as an oil pump may be supplied into the differential case C via an oil passage (not illustrated) provided in the drive axles A1 and A2 and/or the differential case C. Alternatively, the helical grooves 18 and 19 may be formed in outer peripheral faces of the drive axles A1 and A2.

The structure of the differential mechanism 3 within the differential case C is now explained. The differential mechanism 3 includes a first transmission member 5 that is linked so as to rotate integrally with the first side wall Ca with the first axis X1 as a central axis (formed integrally in this embodiment), an eccentric rotating member 6 that integrally has a first transmission shaft S1 that is rotatable around the first axis X1 and an eccentric shaft portion 6e having as a central axis a second axis X2 that is eccentric from the first axis X1 only by a predetermined amount of eccentricity e, an annular second transmission member 8 that has one side part disposed so as to oppose the first transmission member 5 and is rotatably supported on the eccentric shaft portion 6e via a bearing 7, which is a ball bearing, a third transmission member 9 that is disposed so as to oppose the other side part of the second transmission member 8 and has its back face opposing an inner face of the second side wall Cb, a first transmission mechanism T1 that can transmit torque between the first and second transmission members 5 and 8 while changing the speed, and a second transmission mechanism T2 that can transmit torque between the second and third transmission members 8 and 9 while changing the speed.

The eccentric rotating member 6 has a first transmission shaft S1 having a cylindrical shape, which serves as a main shaft part thereof, and the first drive axle A1 having the first axis X1 as a central axis is spline-fitted by a spline fitting 16 into an inner peripheral face of the first transmission shaft S1.

Furthermore, the third transmission member 9 has a ring plate-shaped form having the first axis X1 as a central axis, and a cylindrical second transmission shaft S2 extending outward in the axial direction is coaxially linked to an end part of the inner periphery of the third transmission member 9 (integrally formed in this embodiment). The second drive axle A2 having the first axis X1 as a central axis is spline-fitted by a spline fitting 17 into an inner peripheral face of the second transmission shaft S2. A missing tooth portion 17c, serving as a passage for lubricating oil, is provided in part of the site of the spline fitting 17 in the peripheral direction.

Due to the second transmission member 8 being fitted onto and supported on the eccentric shaft portion 6e of the eccentric rotating member 6 rotating around the first axis X1 so that the second transmission member 8 can rotate around the second axis X2, the second transmission member 8 can revolve around the first axis X1 with respect to the first transmission shaft S1 while rotating around the second axis X2 with respect to the eccentric shaft portion 6e accompanying rotation of the eccentric rotating member 6 around the first axis X1.

Furthermore, the second transmission member 8 includes a ring plate-shaped first half body 8a rotatably supported on the eccentric shaft portion 6e of the eccentric rotating member 6 via the bearing 7, a ring plate-shaped second half body 8b opposing the first half body 8a across a gap, and a basically cylindrical linking member 8c integrally linking the two half bodies 8a and 8b. In this embodiment in particular, the first half body 8a and the second half body 8b are fitted into an inner peripheral face of one end part and the other end part of the linking member 8c respectively in a spigot joint manner, and the fitted part is fixed by appropriate fixing means such as welding or swaging. The first transmission mechanism T1 is provided between mutually opposing faces of the first half body 8a and the first transmission member 5, and the second transmission mechanism T2 is provided between mutually opposing faces of the second half body 8b and the third transmission member 9.

The linking member 8c is provided with a plurality of first oil flow holes 11 at equal intervals in the peripheral direction, the first oil flow holes 11 providing communication between an internal space IC of the differential case C and a hollow part SP of the second transmission member 8, thus enabling lubricating oil scattered in the internal space IC of the differential case C to be guided into the hollow part SP through the first oil flow holes 11. Furthermore, formed in the second half body 8b is a second oil flow hole 12 providing communication between the hollow part SP and an inner peripheral side of the second transmission mechanism T2.

Furthermore, the differential mechanism 3 includes a balance weight W relatively non-rotatably mounted on the first transmission shaft S1, which is the main shaft portion of the eccentric rotating member 6, the balance weight W having the opposite phase to an overall center of gravity G of the second transmission member 8 and the eccentric shaft portion 6e of the eccentric rotating member 6 with respect to the first axis X1 and having a rotational radius that is larger than the rotational radius of the overall center of gravity G. This balance weight W is formed from an annular base part Wm that is fixed to the first transmission shaft S1 by a clip 10 and a weight part Ww that is fixedly provided on a predetermined region in the peripheral direction of the annular base part Wm, and the hollow part SP of the second transmission member 8 is utilized as a housing space for the balance weight W.

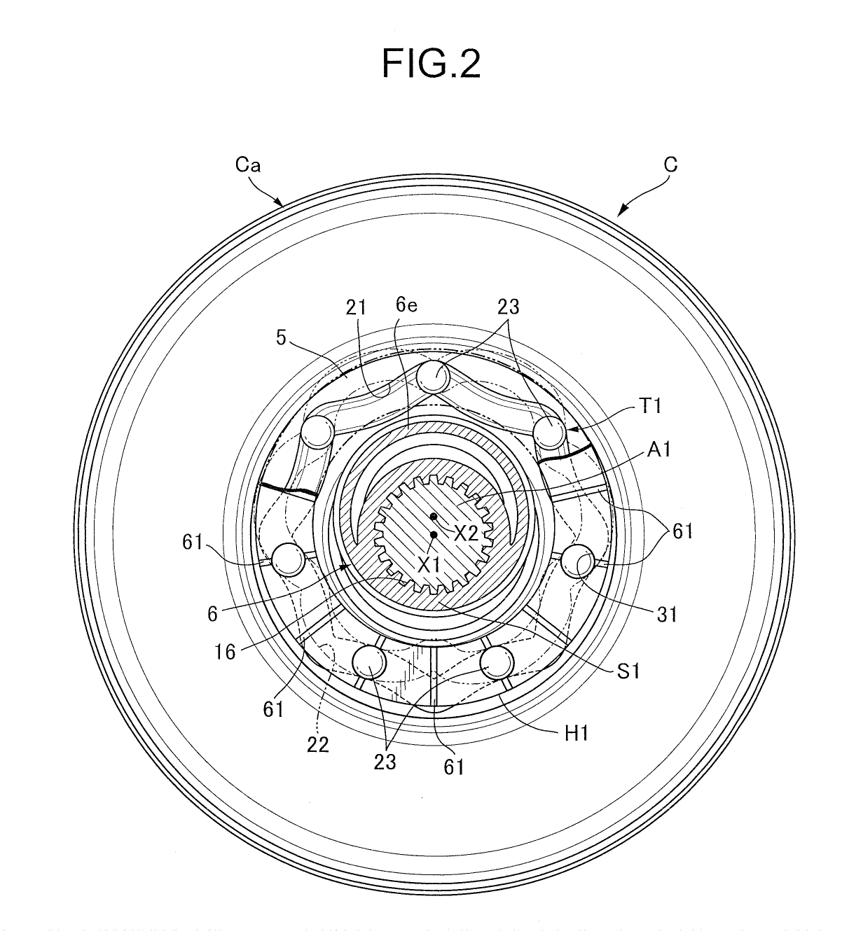

As shown in FIG. 1 and FIG. 2, a wave-shaped annular first transmission groove 21 having the first axis X1 as a center is formed in an inside face, opposing one side part (the first half body 8a) of the second transmission member 8, of the first transmission member 5, and this first transmission groove 21 extends in the peripheral direction along a hypotrochoid curve having as a base circle a virtual circle having the first axis X1 as its center in the illustrated example. On the other hand, a wave-shaped annular second transmission groove 22 having the second axis X2 as a center is formed in one side part (the first half body 8a), opposing the first transmission member 5, of the second transmission member 8. The second transmission groove 22 extends in the peripheral direction along an epitrochoid curve having as a base circle a virtual circle having the second axis X2 as a center in the illustrated example, has a wave number that is smaller than the wave number of the first transmission groove 21, and intersects the first transmission groove 21 at a plurality of locations. A plurality of first balls 23 as first rolling bodies are disposed in intersecting parts (that is, overlapping parts) between the first transmission groove 21 and the second transmission groove 22, each first ball 23 being capable of rolling on inside faces of the first and second transmission grooves 21 and 22.

A ring plate-shaped first retainer H1 is disposed between opposing faces of the first transmission member 5 and the second transmission member 8 (the first half body 8a). The first retainer H1 has a plurality of circular first retaining holes 31 at equal intervals in the peripheral direction, the plurality of circular first retaining holes 31 rotatably retaining the plurality of first balls 23 while keeping the gap therebetween constant so that a state in which the plurality of first balls 23 are engaged with the first and second transmission grooves 21 and 22 in the mutually intersecting parts between the two transmission grooves 21 and 22 can be maintained.

Furthermore, as shown in FIGS. 1, 2 and 4, a wave-shaped annular third transmission groove 24 having the second axis X2 as a center is formed in the other side part (the second half body 8b) of the second transmission member 8, and the third transmission groove 24 extends in the peripheral direction along a hypotrochoid curve having as a base circle a virtual circle having the second axis X2 as a center in the illustrated example. On the other hand, a wave-shaped annular fourth transmission groove 25 having the first axis X1 as a center is formed in a face, opposing the second transmission member 8, of the third transmission member 9. The fourth transmission groove 25 extends in the peripheral direction along an epitrochoid curve having as a base circle a virtual circle having the first axis X1 as a center in the illustrated example, has a smaller wave number than the wave number of the third transmission groove 24, and intersects the third transmission groove 24 at a plurality of locations. A plurality of second balls 26 as second rolling bodies are disposed in intersecting parts (overlapping parts) of the third transmission groove 24 and the fourth transmission groove 25, and each second ball 26 can roll on inside faces of the third and fourth transmission grooves 24 and 25. Furthermore, in the present embodiment, the trochoid coefficient of the first and second transmission grooves 21 and 22 is set at a value that is different from the trochoid coefficient of the third and fourth transmission grooves 24 and 25.

A ring plate-shaped second retainer H2 is disposed between mutually opposing faces of the third transmission member 9 and the second transmission member 8 (the second half body 8b). The second retainer H2 has a plurality of circular second retaining holes 32 at equal intervals in the peripheral direction, the second retaining holes 32 rotatably retaining the plurality of second balls 26 while keeping the gap therebetween constant so that a state in which the plurality of second balls 26 are engaged with the third and fourth transmission grooves 24 and 25 in intersecting parts of the two transmission grooves 24 and 25 can be maintained.

Opposing faces of the first retainer H1 and the first and second transmission members 5 and 8 and opposing faces of the second retainer H2 and the second and third transmission members 8 and 9 are retained in a contacted state in which they can rotate and slide. In order to attain and maintain the contacted state, in this embodiment each of the retainers H1 and H2 is formed so as to have a sufficient plate thickness that enables a state in which it is rotatably and slidably in contact with the transmission members 5, 8; 8, 9 on opposite sides to be attained (that is, the plate thickness corresponds to a size that is the same as or slightly smaller than a gap between the transmission members 5, 8; 8, 9 sandwiching the retainers H1 and H2 from opposite sides when the transmission members 5, 8, 9 are in a properly assembled state within the differential case C), and a thrust washer 13 as retaining means that retains the above contacted state is disposed between the second side wall Cb of the differential case C and the third transmission member 9. In addition to the original function as a thrust washer that allows smooth relative rotational sliding between the second side wall Cb and the third transmission member 9, this thrust washer 13 functions as a shim for adjusting a small clearance (that is, a sliding gap) between the opposing faces by selecting the thickness for the washer itself.

In this specification, the ‘contacted state’ between the retainers H1 and H2 and the transmission members 5 and 8, and 9 referred to not only includes a state in which mutually opposing faces of the retainers H1 and H2 and the transmission members 5, 8, and 9 make physical contact in a rotatably slidable state but also includes a contacted state in which the retainers H1 and H2 and the transmission members 5, 8, and 9 closely oppose each other and substantially make contact in a state in which there is a small clearance that enables an oil film necessary for lubrication to be formed and retained between the mutually opposing faces.

Moreover, in the present embodiment, as clearly shown in FIG. 5, in a state in which the transmission mechanisms T1 and T2 are subjected to no load (that is, there is no transmission), all of the plurality of first balls 23 are given a play 45 in the thrust direction and a play in the rotational direction between the first and second transmission members 5 and 8 and all of the plurality of second balls 26 are given a play 46 in the thrust direction and a play in the rotational direction between the second and third transmission members 8 and 9. Even if such play (that is, backlash) is present, when the differential device D is carrying out transmission, that is, the transmission mechanisms T1 and T2 are in a loaded state, at least three of the first and second balls 23 and 26, which carry out transmission of torque between the transmission members 5, 8 and 9, engage with inside faces of the transmission grooves 21, 22; 24, 25 on opposite sides in the torque transmission direction without rattling, and transmission of torque via the respective balls 23 and 26 can be carried out without problems.

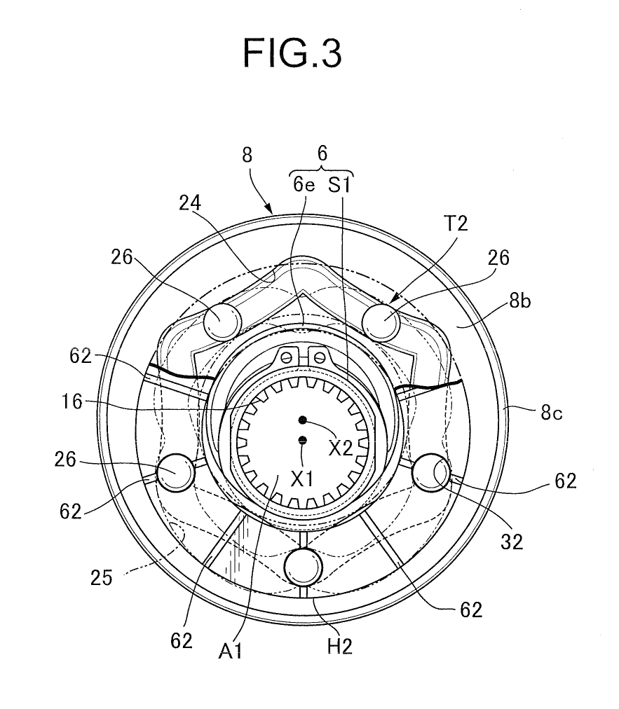

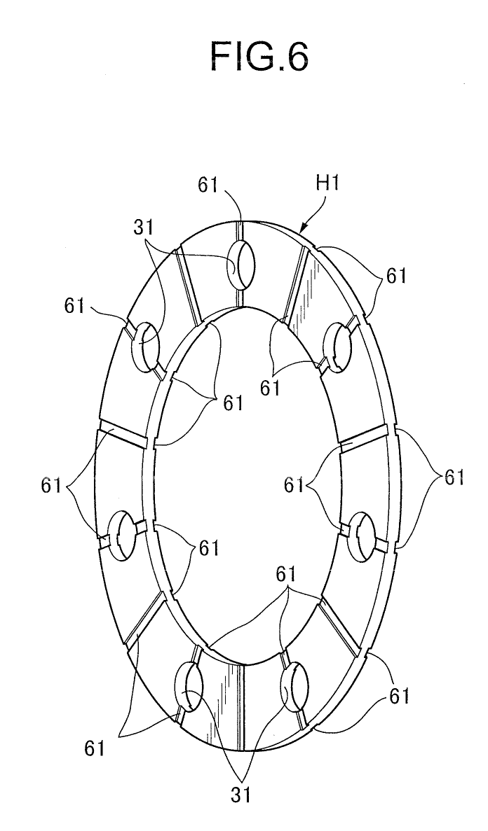

Furthermore, in this embodiment, a plurality of first oil reservoir recesses 61 are provided as clearly shown in FIG. 2, FIG. 5(A) and FIG. 6 in at least one opposing face among the mutually opposing faces between the first retainer H1 and each of the first and second transmission members 5 and 8 (in the illustrated example, one side face and opposite side faces of the first retainer H1), the plurality of first oil reservoir recesses 61 being capable of retaining lubricating oil between the one opposing face and the other opposing face (that is, the first and second transmission members 5 and 8). Moreover, a plurality of second oil reservoir recesses 62 are provided as shown in FIG. 3 and FIG. 5(B) in at least one opposing face among the mutually opposing faces between the second retainer H2 and each of the second and third transmission members 8 and 9 (in the illustrated example, one side face and opposite side faces of the second retainer H2), the plurality of second oil reservoir recesses 62 being capable of retaining lubricating oil between the one opposing face and the other opposing face (that is, the second and third transmission members 8 and 9).

In this embodiment in particular, the oil reservoir recesses 61 and 62 are formed from a plurality of channels provided at intervals in the peripheral direction in faces, opposing the transmission members 5, 8 and 9, of the first and second retainers H1 and H2, which have a ring plate shape, and transecting the retainers H1 and H2 in the radial direction, and opposite ends of each of the oil reservoir recesses 61 and 62 open on an inner peripheral face and an outer peripheral face of the respective retainers H1 and H2. In the first and second retainers H1 and H2, some of the oil reservoir recesses 61 and 62 extend so as to transect the first and second retaining holes 31 and 32, thus ensuring a smooth transfer of lubricating oil between the retaining holes 31 and 32 and the oil reservoir recesses bland 62.

In the illustrated example, the oil reservoir recesses bland 62 are straight grooves extending in the radial direction of the first and second retainers H1 and H2, but they may be straight grooves that are inclined with respect to the radial direction, or may be non-straight grooves in which at least part thereof is curved or bent.

Furthermore, a ring-shaped first oil passage 41 is formed between mutually opposing faces of the eccentric rotating member 6 and the inside face of the first side wall Ca of the differential case C, the first oil passage 41 providing communication between an opening at the inner end of the first helical groove 18 and the inner peripheral side of the first transmission mechanism T1. The first helical groove 18 and the first oil passage 41 form, in cooperation with each other, a first oil inlet path P1 that guides lubricating oil from the interior of the transmission case 1 toward the inner peripheral side of the first retainer H1 between the fitting faces of the first bearing boss B1 and the first drive axle A1.

Moreover, a ring-shaped second oil passage 42 is formed between mutually opposing faces of the inside face of the second side wall Cb of the differential case C and the outside face of the third transmission member 9, the second oil passage 42 allowing the opening at the inner end of the second helical groove 19 to communicate with the inner peripheral side of the thrust washer 13. Furthermore, the second helical groove 19 and the missing tooth portion 17c of the spline fitting part 17 form, in cooperation with each other, a second oil inlet path P2 that guides lubricating oil from the interior of the transmission case 1 toward the inner peripheral side of the second retainer H2 between the fitting faces of the second bearing boss B2 and the second drive axle A2.

In the present embodiment explained above, when the wave number of the first transmission groove 21 is Z1, the wave number of the second transmission groove 22 is Z2, the wave number of the third transmission groove 24 is Z3, and the wave number of the fourth transmission groove 25 is Z4, the first to fourth transmission grooves 21, 22, 24 and 25 are formed so that the equation below holds.

(Z1/Z2)×(Z3/Z4)=2

Desirably, as shown in the illustrated example, Z1=8, Z2=6, Z3=6, and Z4=4 or Z1=6, Z2=4, Z3=8, and Z4=6.

In the illustrated example, the first transmission groove 21 having eight waves and the second transmission groove 22 having six waves intersect at seven locations, seven of the first balls 23 being disposed in the seven intersecting parts (overlapping parts), and the third transmission groove 24 having six waves and the fourth transmission groove 25 having four waves intersect at five locations, five of the second balls 26 being disposed in the five intersecting parts (overlapping parts).

The first transmission groove 21, the second transmission groove 22, and the first balls 23 form the first transmission mechanism T1, which can transmit torque between the first transmission member 5 and the second transmission member 8 while changing the speed, and the third transmission groove 24, the fourth transmission groove 25, and the second balls 26 form the second transmission mechanism T2, which can transmit torque between the second transmission member 8 and the third transmission member 9 while changing the speed.

In the present embodiment explained above, the first and second transmission mechanisms T1 and T2 form the transmission mechanism related to the first aspect of the present invention. In the first transmission mechanism T1 in particular, the first transmission member 5 forms one transmission member and the second transmission member 8 forms the other transmission member, and the first transmission groove 21 forms one transmission groove and the second transmission groove 22 forms the other transmission groove. In the second transmission mechanism T2 in particular, the third transmission member 9 forms one transmission member and the second transmission member 8 forms the other transmission member, and the fourth transmission groove 25 forms one transmission groove and the third transmission groove 24 forms the other transmission groove.

The operation of the first embodiment is now explained.

When, for example, in a state in which the eccentric rotating member 6 (and consequently the eccentric shaft portion 6e) is fixed by fixing the right first drive axle A1, the ring gear Cg is driven with the power from the engine, and the differential case C, and consequently the first transmission member 5, are rotated around the first axis X1, the eight wave-shaped first transmission groove 21 of the first transmission member 5 drives the six wave-shaped second transmission groove 22 of the second transmission member 8 via the first balls 23, and the first transmission member 5 therefore drives the second transmission member 8 with a speed increase ratio of 8/6. In accordance with rotation of the second transmission member 8, since the six wave-shaped third transmission groove 24 of the second transmission member 8 drives the four wave-shaped fourth transmission groove 25 of the third transmission member 9 via the second balls 26, the second transmission member 8 drives the third transmission member 9 with a speed increase ratio of 6/4.

Ultimately, the first transmission member 5 drives the third transmission member 9 with a speed increase ratio of

(Z1/Z2)×(Z3/Z4)=(8/6)×(6/4)=1.

On the other hand, when, in a state in which the third transmission member 9 is fixed by fixing the left second drive axle A2, the differential case (and consequently the first transmission member 5) is rotated, due to the rotational driving force of the first transmission member 5 and the drive reaction force of the second transmission member 8 against the third transmission member 9, which is immobile, the second transmission member 8 revolves around the first axis X1 while rotating around the eccentric shaft portion 6e (the second axis X2) of the eccentric rotating member 6, thus driving the eccentric shaft portion 6e around the first axis X1. As a result, the first transmission member 5 drives the eccentric rotating member 6 with a speed increase ratio of two.

When the load of the eccentric rotating member 6 and the load of the third transmission member 9 are in balance with each other or are changed from each other, the amount of rotating and the amount of revolving of the second transmission member 8 change steplessly, and the average value of the rotational speeds of the eccentric rotating member 6 and the third transmission member 9 becomes equal to the rotational speed of the first transmission member 5. In this way, the rotation of the first transmission member 5 is distributed between the eccentric rotating member 6 and the third transmission member 9, and the rotational power transmitted from the ring gear Cg to the differential case C can therefore be distributed between the left and right drive axles A1 and A2.

In this process, by making Z1=8, Z2=6, Z3=6 and Z4=4 or Z1=6, Z2=4, Z3=8 and Z4=6, the structure can be simplified while ensuring the differential function.

In this differential device D, since the rotational torque of the first transmission member 5 is transmitted to the second transmission member 8 via the first transmission groove 21, the plurality of first balls 23, and the second transmission groove 22, and the rotational torque of the second transmission member 8 is transmitted to the third transmission member 9 via the third transmission groove 24, the plurality of second balls 26, and the fourth transmission groove 25, transmission of torque between the first transmission member 5 and the second transmission member 8 and between the second transmission member 8 and the third transmission member 9 is carried out by dispersing it between a plurality of locations where the first and second balls 23 and 26 are present, thus increasing the strength and lightening the weight of each of the transmission elements, such as the first to third transmission members 5, 8 and 9 and the first and second balls 23 and 26.

Furthermore, in this differential device D the first to third transmission members 5, 8, and 9 can be flattened in the axial direction as much as possible and, moreover, the first transmission mechanism T1 between the mutually opposing faces of the first and second transmission members 5 and 8 and the second transmission mechanism T2 between the mutually opposing faces of the second and third transmission members 8 and 9 are formed so that when the eccentric rotating member 6 is fixed the third transmission member 9 is driven with a speed increase ratio of two times from the first transmission member 5. Therefore, a differential device D can be obtained that can easily be flattened in the axial direction so that a small size can be achieved.

Moreover, while the differential device D is carrying out transmission, as described above, lubricating oil collecting in the bottom part of the transmission case 1 is stirred by means of the differential case C, etc. and is scattered over a wide range within the transmission case 1, and some of the scattered lubricating oil is actively supplied to the interior of the differential case C from opposite sides thereof by the drawing-in action of the first and second helical grooves 18 and 19 accompanying relative rotation of the drive axles A1 and A2 and the bearing bosses B1 and B2 of the differential case C.

In this process, some of the lubricating oil that has reached the outlet of the first helical groove 18 in particular flows toward the inner peripheral side of the first transmission mechanism T1 (and therefore toward the inner peripheral side of the first retainer H1) via the first oil passage 41 by the action of centrifugal force, thereby efficiently lubricating for example rotationally sliding surfaces between the first retainer H1 and the first and second transmission grooves 21 and 22 or an engagement part between the first ball 23 and the first and second transmission grooves 21 and 22.

On the other hand, some of the lubricating oil that has reached the outlet of the second helical groove 19 goes toward the thrust washer 13 via the second oil passage 42 by the action of centrifugal force and lubricates the washer. The rest of the lubricating oil is introduced into the interior of the third transmission member 9 through the spline fitting part 17 (mainly the spline missing tooth portion 17c), and some of the introduced lubricating oil flows outward in the radial direction by virtue of centrifugal force and flows toward the inner peripheral side of the second transmission mechanism T2 (that is, the inner peripheral side of the second retainer H2), thereby efficiently lubricating for example rotationally sliding surfaces between the second retainer H2 and the third and fourth transmission grooves 24 and 25 and an engagement part between the second ball 26 and the third and fourth transmission grooves 24 and 25.

In this embodiment, the opposing faces of the first retainer H1 and the first and second transmission members 5 and 8 and the opposing faces of the second retainer H2 and the second and third transmission members 8 and 9 are in the rotatably and slidably contacted state as described above, and this rotatably and slidably contacted state is appropriately retained by the thrust washer 13 as retaining means being disposed between the third transmission member 9 and the second side wall Cb of the differential case C. As a result, it is possible by increasing the plate thickness of each of the retainers H1 and H2 as much as possible (that is, substantially the same as the gap between the mutually opposing transmission members 5, 8; 8, 9 sandwiching the retainer from opposite sides) to enhance the rigidity with which the balls 23 and 26 are retained by the retainers H1 and H2. Moreover, since the play in the thrust direction between the retainers H1 and H2 and the transmission members 5, 8; 8, 9 is substantially zero or is eliminated as much as possible, it becomes possible to suppress effectively excessive tilting or vibration in the thrust direction of the retainers H1 and H2 during transmission, and the effect in enhancing the rigidity of the retainers H1 and H2 coupled with the effect in suppressing excessive tilting and vibration enables the plurality of balls 23 and 26 to be appropriately retained by the retainers H1 and H2 during transmission.

In this way, when some of the plurality of balls 23 (26) retained by the retainer H1 (H2) are about to be disturbed while passing through a sharply changing curvature part of the transmission grooves 21 and 22 (24 and 25), each retainer H1 (H2) having maintained the appropriate attitude and a sufficient thickness (and therefore rigidity) can suppress effectively disturbance of the some of the balls 23 (26) in cooperation with the other balls 23 (26), which are not disturbed, and it is therefore possible to ensure smooth rolling of the plurality of balls 23 (26) as a whole along the transmission grooves 21 and 22 (24 and 25), thereby improving the overall transmission efficiency.

Moreover, when the differential device D is not carrying out transmission, that is, when the transmission mechanisms T1 and T2 are in a no-load state, since the play 45 in the thrust direction and the play in the rotational direction between the first and second transmission members 5 and 8 are given to all of the plurality of first balls 23 and the play 46 in the thrust direction and the play in the rotational direction between the second and third transmission members 8 and 9 are given to all of the plurality of second balls 26, even if the transmission grooves 21, 22; 24, 25 have some manufacturing tolerance, this can be absorbed by the play. For example, when assembling the device, there is no possibility that the balls 23 and 26 will interfere with the rotatably and slidably contacted state between the retainers H1 and H2 and the transmission members 5, 8; 8, 9 on opposite sides, that is, an appropriate contacted state between the retainers H1 and H2 and the transmission members 5, 8; 8, 9 can be obtained without interference from the balls 23 and 26, thereby giving very good ease of production and ease of assembly of the transmission mechanisms T1 and T2.

Furthermore, in the present embodiment, although the retaining means is formed from a ring-shaped shim (that is, the thrust washer 13), because the plate thicknesses of the transmission members 5, 8 and 9 and the retainers H1 and H2 can naturally be set with high precision, it is easy to select a thickness for the thrust washer 13 so that a rotatably and slidably contacted state can be retained between the opposing faces of the first retainer H1 and the first and second transmission members 5 and 8 and the opposing faces of the second retainer H2 and the second and third transmission members 8 and 9, and the range from which the thickness of the thrust washer 13 is selected can be small, thus further improving the ease of assembly. Moreover, since the thrust washer 13 also exhibits its original function as a thrust washer of reducing rotational friction between the third transmission member 9 and the other side wall Cb of the differential case C, the durability of the third transmission member 9 and the differential case C (the second side wall Cb) improves. In this way, due to the thrust washer 13 also functioning as retaining means as described above, the structure of the differential device D can be simplified accordingly.

Moreover, in this embodiment, since the first and second oil inlet paths P1 and P2 are provided for guiding lubricating oil from the interior of the transmission case 1 toward the inner periphery of the first and second retainers H1 and H2 between the fitting faces of the first and second drive axles A1 and A2 and the first and second bearing bosses B1 and B2 of the differential case C, lubricating oil that has been guided toward the inner periphery of the retainers H1 and H2 through the oil inlet paths P1 and P2 can efficiently and sufficiently form an oil film on the opposing faces of the first retainer H1 and the first and second transmission members 5 and 8 and the opposing faces of the second retainer H2 and the second and third transmission members 8 and 9 by virtue of centrifugal force due to rotation of the retainers H1 and H2 and capillary action. From this, even if the retainers H1 and H2 are always or often made to be in sliding contact with the transmission members 5, 8; 8, 9, the friction of the sliding contact face can be reduced, and the transmission efficiency and durability of the differential device D are improved.

In addition, for example, chamfers 34 and 35 shown by a double-dotted broken line in FIGS. 5(A) and (B), that is, an oil guiding face, may be provided on an end part of the inner periphery of opposite side faces of each of the retainers H1 and H2. In this case, by the action of guiding by the chamfers 34 and 35, lubricating oil that has been guided toward the inner periphery of the first and second retainers H1 and H2 can be more efficiently guided and supplied to the opposing faces.

While the differential device D is carrying out transmission, when lubricating oil enters between the mutually opposing faces of the retainers H1 and H2 and the transmission members 5, 8; 8, 9 by capillary action as described above, an oil film is formed on the mutually opposing faces, and in this embodiment in particular one of the mutually opposing faces of the first retainer H1 and the first and second transmission members 5 and 8 (one side face and the other side face of the first retainer H1) is provided with the plurality of first oil reservoir recesses 61 that can retain lubricating oil between themselves and the other mutually opposing face (the first and second transmission members 5 and 8), and also one of the mutually opposing faces of the second retainer H2 and the second and third transmission members 8 and 9 (one side face and the other side face of the second retainer H2) is provided with the plurality of second oil reservoir recesses 62 that can retain lubricating oil between themselves and the other mutually opposing face (the second and third transmission members 8 and 9).

Due to such oil reservoir recesses 61 and 62 being specially provided, some of the lubricating oil forming the oil film is moved by being dragged by the partnering rotational plane accompanying relative rotation between the retainers H1 and H2 and the transmission members 5, 8; 8, 9, thus making it easy for it to be trapped and retained in the oil reservoir recesses 61. The lubricating oil thus trapped and retained can prevent effectively the oil film on the mutually opposing faces from becoming discontinuous, the effect of the oil film in lubricating the mutually opposing faces can be exhibited sufficiently, and frictional resistance of the retainers H1 and H2 with respect to the transmission members 5, 8; 8, 9 can be reduced effectively.

Moreover, in this embodiment, as clearly shown in FIG. 6, the oil reservoir recesses bland 62 are formed from a plurality of channels transecting the ring plate-shape retainers H1 and H2 in the radial direction, and opposite ends of the channels 61 and 62 open on the inner peripheral face and the outer peripheral face of the retainers H1 and H2. Because of this, when the transmission mechanisms T1 and T2 are carrying out transmission, since old lubricating oil is sufficiently replaced with new in the channels 61 and 62, it is always possible to form a new oil film on the mutually opposing faces of the retainers H1 and H2 and the transmission members 5, 8; 8, 9 on the opposite sides, thus enhancing the transmission efficiency and efficiently cooling the mutually opposing faces.

### Second Embodiment

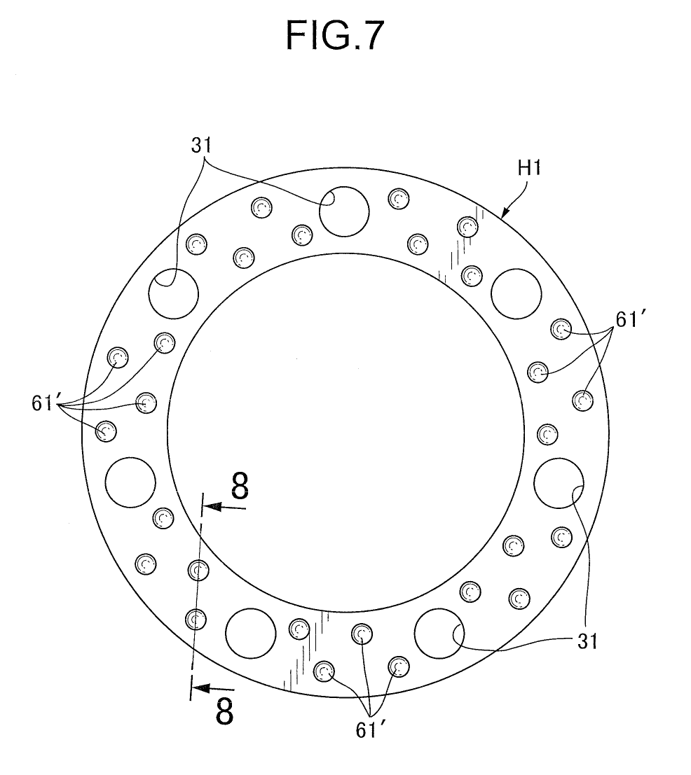

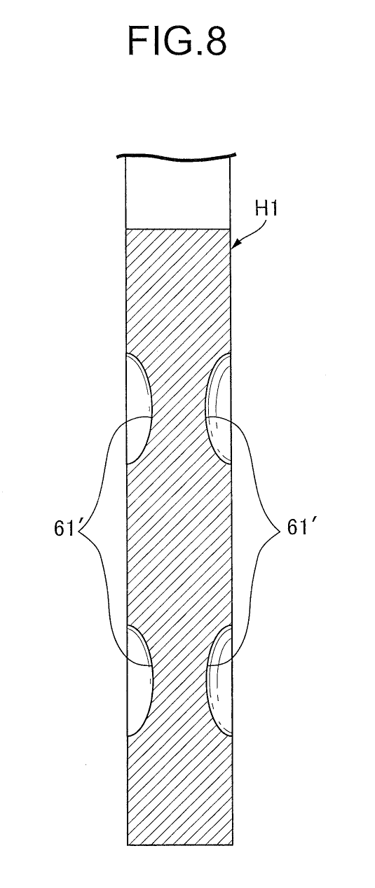

FIG. 7 and FIG. 8 show a second embodiment of the present invention. In this second embodiment, a first oil reservoir recess is formed from a plurality of dimples 61′ that are indented with gaps therebetween in at least one of mutually opposing faces of the first retainer H1 and each of the first and second transmission members 5 and 8 (in the illustrated example, one side face and the other side face of the first retainer H1), and a second oil reservoir recess is formed from a plurality of dimples 62′ that are indented with gaps therebetween in at least one of opposing faces of the second retainer H2 and each of the second and third transmission members 8 and 9. In the figures, in FIGS. 7 and 8 only the dimples 61′ as the first oil reservoir recess are illustrated and the dimples 62′ as the second oil reservoir recess are omitted, but the arrangement of the dimples 62′ is the same as that of the dimples 61′.

In the second embodiment, the arrangement is otherwise the same as that of the first embodiment; respective constituent elements are denoted by the same reference numerals and symbols as for the constituent elements of the first embodiment, further explanation thereof being omitted. In the second embodiment also, the same operational effects as those of the first embodiment can be achieved.

Furthermore, in the second embodiment, even in a state in which the transmission mechanisms T1 and T2 are stopped for a long period of time, since sufficient lubricating oil can be retained continuously in each of the dimples 61′ and 62′, an oil film is quickly formed on the mutually opposing faces of the retainers H1 and H2 and the transmission members 5, 8; 8, 9 on opposite sides from the time when transmission of the transmission mechanisms T1 and T2 is started, thus enhancing the transmission efficiency.

Embodiments of the present invention are explained above, but the present invention may be modified in a variety of ways as long as the modifications do not depart from the spirit and scope thereof.

For example, in the embodiments, the differential device D is illustrated as the transmission device, and the power inputted from a power source into the differential case C (the first transmission member 5) is distributed between the first and second transmission shafts S1 and S2 via the first and second transmission mechanisms T1 and T2 while allowing differential rotation, but the present invention can be applied to various types of transmission device other than a differential device. For example, the differential device D of the embodiments can be converted to a transmission (a speed-reducing gear or a speed-increasing gear) by defining a casing corresponding to the differential case C of the embodiments as a fixed transmission case, defining either one of the first and second transmission shafts Si and S2 as an input shaft, and defining the other thereof as an output shaft, the rotational torque inputted into the input shaft being changed in speed (decreased in speed or increased in speed) and transmitted to the output shaft, and in this case such a transmission (speed-reducing gear or speed-increasing gear) is considered to be the transmission device of the present invention. In this case, the transmission may be a transmission for a vehicle or may be a transmission for various types of mechanical equipment other than a vehicle.

Furthermore, in the embodiments, the differential device D as a transmission device is housed in the automobile transmission case 1 for an automobile, but the differential device D is not limited to an automobile differential device and may be implemented as a differential device for various types of mechanical equipment.

Moreover, the embodiments illustrate one in which the differential device D as a transmission device is applied to a left and right wheel transmission system and power is distributed to the left and right drive axles A1 and A2 while allowing differential rotation, but in the present invention the differential device as a transmission device may be applied to a front and rear wheel transmission system of a front and rear wheel drive vehicle, and power may be distributed to front and rear drive wheels while allowing differential rotation.

Furthermore, the second transmission member 8 of the embodiments is formed in a divided manner from the first and second half bodies 8a and 8b and the linking member 8c, but the second transmission member 8 may be formed from an integrated plate-shaped member (for example a sintered product) in which the second transmission groove 22 is provided in one face of the plate-shaped member and the third transmission groove 24 is provided in the other face.

Moreover, in the embodiments, each of the transmission grooves 21, 22; 24, 25 of the first and second transmission mechanisms T1 and T2 is a wave-shaped annular groove along a trochoidal curve, but these transmission grooves are not limited to those of the embodiments, and may be for example a wave-shaped annular groove along a cycloidal curve, or the first transmission groove 21 (or the third transmission groove 24) may be a wave-shaped groove along an epitrochoid curve and the second transmission groove 22 (or the fourth transmission groove 25) may be a wave-shaped groove along a hypotrochoid curve.

Furthermore, in the embodiments, one in which the first and second balls 23 and 26 as first and second rolling bodies are disposed between the first and second transmission grooves 21 and 22 of the first and second transmission mechanisms T1 and T2 and between the third and fourth transmission grooves 24 and 25 is shown, but a roller- or pin-shaped rolling body may be used as the rolling body, and in this case the first and second transmission grooves 21 and 22 and the third and fourth transmission grooves 24 and 25 are formed so as to have an inside face shape that enables a roller- or pin-shaped rolling body to roll.

Moreover, in the embodiments, one in which the eccentric rotating member 6 (first transmission shaft S1) and the third transmission member 9 (second transmission shaft S2) are connected by the spline fittings 16 and 17 to the drive axles A1 and A2 supported on the differential case C and are rotatably supported on the differential case C via the drive axles A1 and A2 is illustrated, but in the present invention the eccentric rotating member 6 (first transmission shaft S1) and the third transmission member 9 (second transmission shaft S2) may be supported directly on the differential case C.

Furthermore, in the embodiments, one in which the first and second retainers H1 and H2 are formed from a ring plate whose inner and outer peripheral faces are each true circles is shown, but the shape of the first and second retainers of the present invention is not limited to that of the embodiments; they may be a ring plate that can retain at least the plurality of first and second balls 23 and 26 at fixed intervals, and they may be for example a ring plate having an elliptical shape or curved into a wave shape.

Moreover, in the embodiments, when assembling the device, an appropriate contacted state is obtained without interference from the plurality of first and second balls 23 and 26 between the retainers H1 and H2 and the transmission members 5, 8; 8, 9 so that the play 45 in the thrust direction and the play in the rotational direction are given to all of the balls 23 between the first and second transmission members 5 and 8 and the play 46 in the thrust direction and the play in the rotational direction are given to all of the balls 26 between the second and third transmission members 8 and 9 in a state in which no load is applied to the transmission mechanisms T1 and T2, but when the appropriate contacted state can be obtained without giving the plays 45 and 46 by increasing the manufacturing precision for the transmission grooves 21, 22, 24, and 25 and the balls 23 and 26, etc., it is not always necessary to give the plays 45 and 46.

Furthermore, in the embodiments, the inner faces of the retaining holes 31 and 32 of the retainers H1 and H2 are simple cylindrical faces, but it is also possible to enhance the effect in lubricating the balls 23 and 26 by providing an oil reservoir recess (for example, an annular groove, a dimple, etc.), which is not illustrated, that can trap and retain lubricating oil on inner faces of the retaining holes 31 and 32.

Moreover, in the embodiments, the thrust washer 13 as retaining means (shim) for retaining a rotatably and slidably contacted state between the opposing faces of the first retainer H1 and the first and second transmission members 5 and 8 and the opposing faces of the second retainer H2 and the second and third transmission members 8 and 9 is disposed between the second side wall Cb and the third transmission member 9, but in the present invention instead of the thrust washer as the retaining means, an elastic member such as a disc spring may be disposed between the second side wall Cb and the third transmission member 9. In this case, the elastic member such as a disc spring may be given a pre-load (that is, a pre-load in the thrust direction), or it may be disposed without applying a pre-load (that is, in a free state). The present invention may also be applied to a case in which, even if the opposing faces are not always in a physically abutting state, the retainers H1 and H2 are slightly tilted or move in the axial direction to thus cause temporary rotational sliding with respect to the transmission members 5, 8, and 9 at least during transmission.

Furthermore, in the embodiments, the first transmission member 5 is formed integrally with the differential case C (first side wall Ca), but a first transmission member 5 may be formed as a separate body from a differential case C (first side wall Ca) and axially slidably and relatively non-rotatably linked to and supported by the first side wall Ca (for example, spline fitted). In this case, a thrust washer (shim) as the retaining means or an elastic member such as a disc spring may be disposed between the first side wall Ca and the first transmission member 5.

Moreover, in the embodiments, the transmission device includes two transmission mechanisms (that is, the first and second transmission mechanisms T1 and T2), but the present invention may be applied to a transmission device that includes one or three or more transmission mechanisms. Furthermore, among a plurality of transmission mechanisms possessed by the transmission device, the present invention may be applied to at least one transmission mechanism, for example, the present invention may be applied to only one transmission mechanism of the first and second transmission mechanisms T1 and T2 of the embodiments.

1. A transmission device comprising
a pair of transmission members that oppose each other, a transmission mechanism that is provided between the two transmission members and can transmit torque while changing a speed therebetween, and a casing that houses the two transmission members, lubricating oil being supplied to an interior of the casing, one transmission member having a first axis as a central axis, the other transmission member being capable of revolving around the first axis while rotating around a second axis that is eccentric from the first axis,
the pair of transmission members each having a transmission groove in mutually opposing faces of the two,
the transmission mechanism comprising one of the transmission grooves provided in said one transmission member and having a wave-shaped annular form with the first axis as a center, the other transmission groove provided in the other transmission member, having a wave-shaped annular form with the second axis as a center, and having a wave number that is different from a wave number of said one transmission groove, a plurality of rolling bodies disposed in a plurality of intersecting parts between said one transmission groove and the other transmission groove and carrying out speed change and transmission between the two transmission members while rolling in the two transmission grooves, and a plate-shaped retainer having a plurality of retaining holes retaining the rolling bodies and being relatively rotatably disposed between the two transmission members,
wherein the retainer is formed to have a plate thickness so that opposite side faces of the retainer are rotatably slidable with respect to the two transmission members, and
at least one opposing face of mutually opposing faces of the retainer and each of the two transmission members is provided with a plurality of oil reservoir recesses that can retain lubricating oil between said one opposing face and the other opposing face.

2. A transmission device comprising
a first transmission member having a first axis as a central axis,
an eccentric rotating member having integrally linked a first transmission shaft rotating around the first axis and an eccentric shaft portion having a second axis eccentric from the first axis as a central axis,
a second transmission member supported on the eccentric shaft portion so that the second transmission member can rotate around the second axis and opposing the first transmission member,
a third transmission member coaxially linked to a second transmission shaft rotating around the first axis and opposing the second transmission member,
a first transmission mechanism capable of transmitting torque between the first and second transmission members while changing a speed,
a second transmission mechanism capable of transmitting torque between the second and third transmission members while changing a speed, and
a casing housing the first to third transmission members and having the first transmission member linked thereto so as to rotate as a unit, lubricating oil being supplied to an interior of the casing,
the first transmission mechanism having a first transmission groove that is present in an opposing face of the first transmission member opposing the second transmission member and has a wave-shaped annular form having the first axis as a center, a second transmission groove that is present in an opposing face of the second transmission member opposing the first transmission member, has a wave-shaped annular form having the second axis as a center, and has a different wave number from a wave number of the first transmission groove, a plurality of first rolling bodies that are disposed in a plurality of intersecting parts of the first and second transmission grooves and carry out speed change and transmission between the first and second transmission members while rolling in the first and second transmission grooves, and a plate-shaped first retainer that has a plurality of first retaining holes rotatably and slidably retaining the first rolling bodies and is disposed between the first and second transmission members,
the second transmission mechanism having a third transmission groove that is present in an opposing face of the second transmission member opposing the third transmission member and has a wave-shaped annular form having the second axis as a center, a fourth transmission groove that is present in an opposing face of the third transmission member opposing the second transmission member, has a wave-shaped annular form having the first axis as a center, and has a different wave number from a wave number of the third transmission groove a plurality of second rolling bodies that are disposed in a plurality of intersecting parts of the third and fourth transmission grooves and carry out speed change and transmission between the second and third transmission members while rolling in the third and fourth transmission grooves, and a plate-shaped second retainer that has a plurality of second retaining holes rotatably and slidably retaining the second rolling bodies and is disposed between the second and third transmission members,
wherein the casing is housed within the transmission case, and first and second bearing bosses rotatably supported on the transmission case are connectedly provided on one side wall and another side wall of the casing respectively,
the first transmission shaft can be coaxially linked to a first drive shaft rotatably supported on the first bearing boss, the second transmission shaft can be coaxially linked to a second drive shaft rotatably supported on the second bearing boss, rotational torque can be distributed from the casing to the first and second drive shafts via the first and second transmission shafts,
the first retainer is formed to have a plate thickness so that opposite side faces of the first retainer are rotatably slidable with respect to the first and second transmission members, the second retainer is formed to have a plate thickness so that opposite side faces of the second retainer are rotatably slidable with respect to the second and third transmission members,
a plurality of first oil reservoir recesses are provided in at least one opposing face among mutually opposing faces of the first retainer and each of the first and second transmission member, the first oil reservoir recesses being capable of retaining lubricating oil between the first oil reservoir recesses and the other opposing face, and a plurality of second oil reservoir recesses are provided in at least one opposing face of mutually opposing faces of the second retainer and each of the second and third transmission members, the second oil reservoir recesses being capable of retaining lubricating oil between the second oil reservoir recesses and the other opposing face.

3. The transmission device according to claim 2, comprising first and second oil inlet paths guiding lubricating oil from an interior of the transmission case toward an inner periphery of the first and second retainers via each of fitting faces between the first and second bearing bosses and the first and second drive shafts.

4. The transmission device according to claim 1, wherein the oil reservoir recess is formed from a plurality of channels provided in an opposing face of the retainer having a ring plate shape opposing the transmission member and transecting the retainer in a radial direction, and opposite ends of the channel open on an inner peripheral face and an outer peripheral face of the retainer respectively.

5. The transmission device according to claim 1, wherein the oil reservoir recess is formed from a plurality of dimples indented in said at least one opposing face with gaps therebetween.

6. The transmission device according to claim 2, wherein the oil reservoir recess is formed from a plurality of channels provided in an opposing face of the retainer having a ring plate shape opposing the transmission member and transecting the retainer in a radial direction, and opposite ends of the channel open on an inner peripheral face and an outer peripheral face of the retainer respectively.

7. The transmission device according to claim 3, wherein the oil reservoir recess is formed from a plurality of channels provided in an opposing face of the retainer having a ring plate shape opposing the transmission member and transecting the retainer in a radial direction, and opposite ends of the channel open on an inner peripheral face and an outer peripheral face of the retainer respectively.

8. The transmission device according to claim 2, wherein the oil reservoir recess is formed from a plurality of dimples indented in said at least one opposing face with gaps therebetween.

9. The transmission device according to claim 3, wherein the oil reservoir recess is formed from a plurality of dimples indented in said at least one opposing face with gaps therebetween.
